(19) United States
(12) Patent Application Publication
(10) Pub. No.: US 2006/0225387 A1
(43) Pub. Date: Oct. 12, 2006

(54) Two-piece filter bag

(76) Inventors: Michael Neate, Copacabana (AU); Brad Currell, Kallangur (AU)

Correspondence Address: FROMMER LAWRENCE & HAUG, 745 FIFTH AVENUE- 10TH FL., NEW YORK, NY, 10151, US

(21) Appl. No.: 11/104,119

(22) Filed: Apr. 12, 2005

(51) Int. Cl. B01D 46/02

(52) U.S. Cl. 55/341.1

(57) ABSTRACT

A bag and cage filter assembly for filtering particulates out of a stream of gas, which includes a plurality of elongated filter bag sections with a support cage, The bag sections are fastened together, as may be the cage sections.

### FIELD OF THE INVENTION

The present invention relates to a filter bag and cage, in particular a two-piece filter bag that allows for maintaining correct bag-to-cage alignment during installation.

### BACKGROUND OF THE INVENTION

Filters have wide commercial applications and utility in industries including but not limited to alumina, wood, plastic, steel, paper, glass, cement, chemical processing, waste incineration, power generation, smelting and mining. Filters generally involve the use of a filter media. Filter media can include but is not limited to: needled felt, nonwoven material, woven material, knitted fabric, fiberglass and/or metal fabrics, foam coated fabrics or a laminate of at least two of these structures. The filter media may or may not require a supporting structure. For example, filters made from a woven or nonwoven textile material for particulate filtration from gas streams are often supported by way of cages made from metal or other suitable material. In operation, the filter removes particulate matter from a gas stream, which flows from the outside of the filter into and through the filter. The particulate accumulates on the outside of the filter and is subsequently collected in a hopper at the base of the filter system.

Filters can take on a variety of shapes. For example, as set forth in U.S. Pat. No. 5,858,039 the disclosure of which is incorporated herein by reference, a filter bag is shown having a star shape. The filter support, or cage, also has a star shape about which the filter media is supported. The star shape of the filter media provides an increased filtering surface area compared to that of a cylindrical filter bag. In addition, the filters can be, but are not limited to, the following configurations: (i) a circular or cylindrical shape; (ii) an oblong shape or oval shape; (iii) an x-shape, y-shape, or any star shape defined as a shape with a plurality of pleats; (iv) any shape with a plurality of sides such as a triangle, quadrilateral, pentagon, hexagon, septagon, octagon, nonagon, decagon, or similar.

Installation of filter bags into pulse jet type dust collectors with single structure cage configurations is typically performed in three sequential steps: (1) feed the filter bag base first through the cell plate from the top; (2) snap the cuff into place in the cell plate orifice; and (3) insert the filter cage down into the bag.

In the typical installation involving a single structure cage configuration, the filter bag is inserted through the cell plate. However, the size and weight of the large rigid single construction cage make it difficult to precisely navigate—especially the first half—through the cell plate orifice. Instead, the bag is usually inserted first and may be slightly collapsed when inserted through the cell plate orifice.

Problems can occur while the filter bag is being inserted. At this step, it is often difficult to maintain the correct alignment of bag and cage as the cage is being installed. Typically this difficulty increases with the length of the bag and cage. Misalignment between the filter bag and cage damages the filter bags. For example, when the cage is incorrectly seated in the base of the bag the lower end of the bag can be subject to holes, tears, and abrasions. Similarly, misalignment can cause unnecessary stress throughout the filter media, which can also lead to holes, tears, and abrasions. At best this wear and tear on the filter bag shortens its normal operating lifespan. At worst, for example in the event of a tear, it renders the bag immediately inoperable.

Filter bag and cage alignment remains a problem despite recent improvements in filter arrangements. For example, a modular filter bag cage is described in U.S. Pat. No. 5,951,726, the disclosure of which is incorporated herein by reference. As noted therein, filters and their support members can be relatively large (i.e. 20-30 feet or more in length) depending upon the application. Unlike the filter media, such a large rigidly constructed cage could not be folded for transportation or storage. Making the cage modular in construction provides for ease in storage and transportation and allows the cage to be readily assembled on site. An additional advantage of the modular configuration is that it makes installation easier in dust collector systems where headroom above the cell plate is restricted.

For such modular configurations, the installation is typically performed in the same three sequential steps as for the single structure cage configurations: (1) feed the filter bag base first through the cell plate from the top; (2) snap the cuff into place in the cell plate orifice; and (3) insert the filter cage down into the bag.

In dust collector systems with restricted headroom above the cell plate, the third step typically contains the additional steps of (a) partially inserting the first filter cage section (b) connecting a subsequent filter cage section (c) partially inserting the connected filter cage sections and (d) repeating steps b and c until the entire filter cage has been inserted into the bag.

Even in modular configurations, the filter bag is of one continuous length and is inserted into the cell plate orifice prior to installation of the cage. For dust collector systems with low cell plate headspace, where the cage is inserted section by section, the problem of bag and cage alignment is exacerbated. As with the single structure cage configuration, this difficulty increases with the length of the bag and cage.

Accordingly, the present invention is directed to overcoming filter bag wear and tear associated with filter bag and cage installation and use.

### SUMMARY OF THE INVENTION

It is therefore an object of the invention to provide for a multipiece filter bag and cage assembly that will maintain proper bag and cage alignment during installation.

It is therefore an object of the invention to provide a multipiece filter bag that will allow for the reduction of filter bag wear and tear during installation.

A further object of the invention is to provide such a filter bag and cage assembly, which is versatile and may be modular in construction.

A further object of the invention is that damaged bag sections of a multipiece bag can be removed and replaced as opposed to having to replace an entire bag.

The objects of the invention will be generally achieved by providing a filter bag assembly comprising a plurality of elongated filter bag sections having a top end, bottom end, inside surface, and outside surface and a means for fastening the filter bag sections together.

Further objects of the invention will be achieved by providing a filter bag and cage assembly comprising: a plurality of elongated filter bag sections having a top end, bottom end, inside surface, and outside surface; a means for fastening the filter bag sections together; a plurality of supporting cage sections having a plurality of longitudinal elements and support elements; and a means for fastening the cage sections together.

Further objects of the invention will be achieved by providing a method of inserting a filter bag assembly into a cell plate orifice comprising the steps of: inserting the bottom section of the filter bag into the cell plate orifice; inserting a single construction cage halfway into the cell plate orifice and into the bottom section of the filter bag; placing a top filter bag section over the top section of the single construction cage; and connecting the filter bag sections.

Further objects of the invention will be achieved by providing a method of inserting a filter bag assembly into a cell plate orifice comprising the steps of: inserting a bottom section of a filter cage into a bottom section of a filter bag; inserting the bottom half or section of the assembled bag and cage through a cell plate orifice; attaching or connecting the top section of the filter bag to the bottom section; securing the assembled filter bag to the cell plate orifice; and inserting and securing the top section of the filter cage into the assembled filter bag.

Further objects of the invention will be achieved by providing a method of inserting a filter bag assembly into a cell plate orifice comprising the steps of: (a) inserting the first section of the filter bag into the cell plate orifice; (b) inserting the first section of the filter cage into the first section of the filter bag; (c) connecting a subsequent filter bag section to the previous section; (d) connecting a subsequent filter cage section to the previous section; and (e) repeating steps (c) and (d) until installation is complete.

### BRIEF DESCRIPTION OF THE DRAWINGS

Further objects and advantages of the invention will become apparent from the following description and claims and from the accompanying drawings wherein:

FIG. 1 is a side sectional view of a typical filter bag application;

FIG. 2 is an image of known filter bag cages with an oblong configuration;

FIG. 3 is an image of known filter bags corresponding to the cages shown in FIG. 2 and illustrating bag damage;

FIGS. 4A-4C illustrate a known method of inserting a filter bag and cage assembly into a pulse jet type dust collector.

FIG. 5 is a cutaway side view of an embodiment of the two-piece filter bag of the present invention shown unassembled;

FIG. 6 is a cutaway side view of an embodiment of the two-piece filter bag of the present invention shown assembled;

FIG. 7 is a cutaway side view of an embodiment incorporating a modular bag cage of the present invention; and

FIG. 8 is a cutaway side view of an embodiment of the assembled two-piece filter bag and assembled modular bag cage of the present invention shown unassembled.

### BRIEF DESCRIPTION OF THE PREFERRED EMBODIMENTS

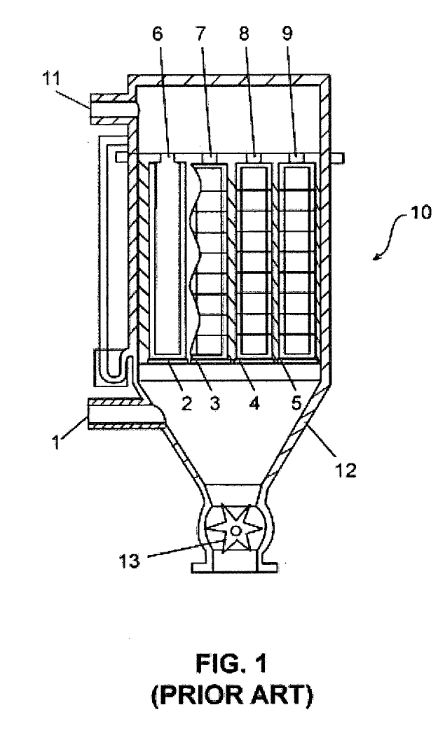

Turning now more particularly to the drawings, the filter bag assembly of the present invention has widespread industrial application. FIG. 1 shows a typical application of a filter bag and cage system. Containment vessel 10 includes a lower lateral input aperture 1 into which a particulate stream to be filtered is input. A plurality of filter bag cages 2, 3, 4, 5 supports a corresponding plurality of filters bags 6, 7, 8, 9 so as to expose the filter bags 6-9 to the particulate gas stream and to prevent the filter bags 6-9 from collapsing. The particulate gas stream is filtered as it passes through the filters 6-9. The filtered gas stream thereafter passes out through upper lateral output aperture 11. The filtered particulates accumulate on the filter bags 6-9 and eventually drop to the inverted conical lower portion 12 of containment vessel 10 to be removed by sweeping device 13.

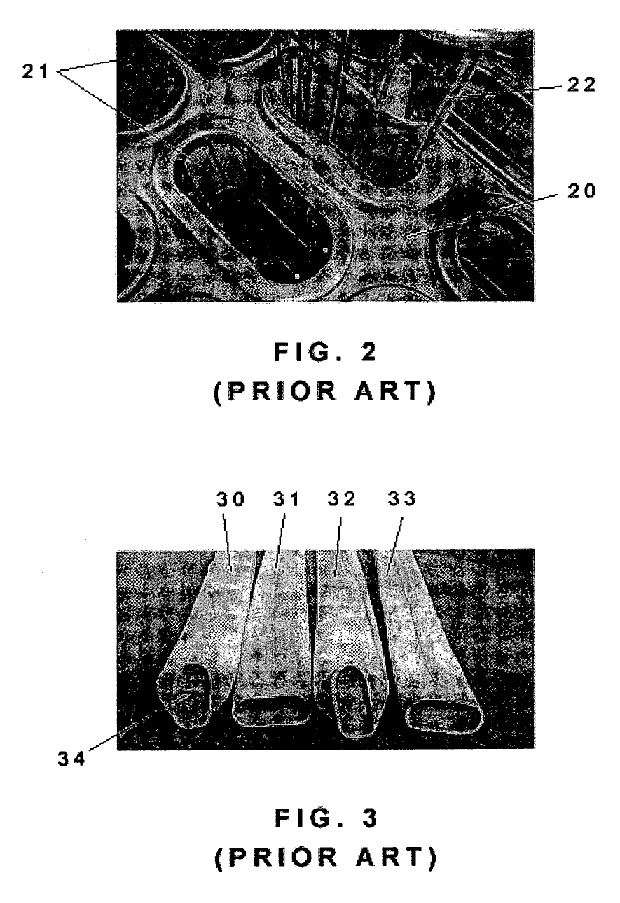

FIG. 2 shows an image of known prior art bag cages having an oblong circumference. The cell plate 20 has a plurality of oblong orifices 21. A plurality cages 22, each having an oblong circumference are show inserted either totally or partially into the orifices 21.

FIG. 3 shows an image of known prior art filter bags associated with the bag cages of FIG. 2. A plurality of bags 30-33 is shown. Each of filter bags 31 and 33 was correctly aligned with its associated bag cage. Filter bags 30 and 32 were incorrectly aligned. As a result of this misalignment, the bags have been malformed at malformation locations 34. These malformation locations also show abrasions. Wear and tear on the filter bags as a result of misalignment leads to shorter filter bag lifespan and a resulting increase in particulate filtration operating cost.

FIGS. 2 and 3 are merely representative of the types of problems associated with misaligned filter bags and bag cages. Other configurations, shapes, and sizes, are also subject stress, wear and tear as a result of bag misalignment. One such other example would be the star configuration described above.

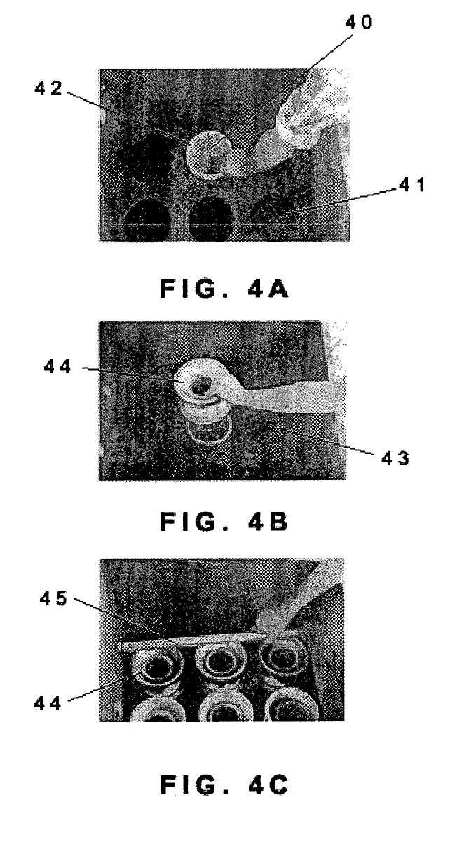

FIG. 4 illustrates a known method of inserting a filter bag and cage assembly into a pulse jet type dust collector. FIG. 4A shows the step of pushing the filter bag 40 through a cell plate orifice 41. FIG. 4A also shows the step of compressing the metal ring located within the top cuff 42 and releasing it such that the filter bag is located in the cell plate with the top cuff above the cell plate and the lower cuff within the chamber. FIG. 4B illustrates the insertion of the retaining cage 43 down into the filter bag ensuring that the Venturi 44 fits snugly over the top cuff. As can be seen in FIG. 4B, retaining cage 43 comprises a plurality of longitudinal members and a plurality of vertical or support members that connect together to give the retaining cage 43 rigidity. FIG. 4C illustrates the positioning of the jet tubes 45, ensuring the holes are facing the Venturi 44 openings.

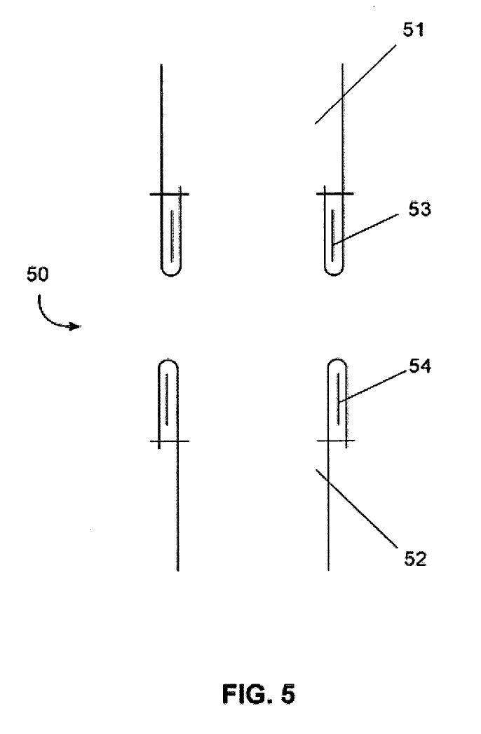

FIG. 5 is a cutaway side view of an embodiment of the two-piece filter bag 50 of the present invention shown unassembled. In this embodiment, the top section 51 and the bottom section 52 are to be fastened together by a mechanism comprising upper metal band 53 and lower metal band 54. In this embodiment, these bands are sewn into the cuffs at the bag ends. The bands can be deformed during installation and will spring back to the manufactured dimension to affect the seal. To connect the two sections, the lower metal band 54 is telescoped into and inserted past the upper metal band 53.

In addition to the fastening mechanism, the bag sections are further secured to the supporting cage and each other during operation as a result of the air pressure of the gas stream. Of course, other means for fastening such as hook-and-clasp, hook and loop (Velcro®, zippers, snaps, adhesives, straps, clips, ties or other means suitable for the purpose may be utilized. Furthermore, although only two sections are shown in FIG. 5, any suitable number of sections may be used.

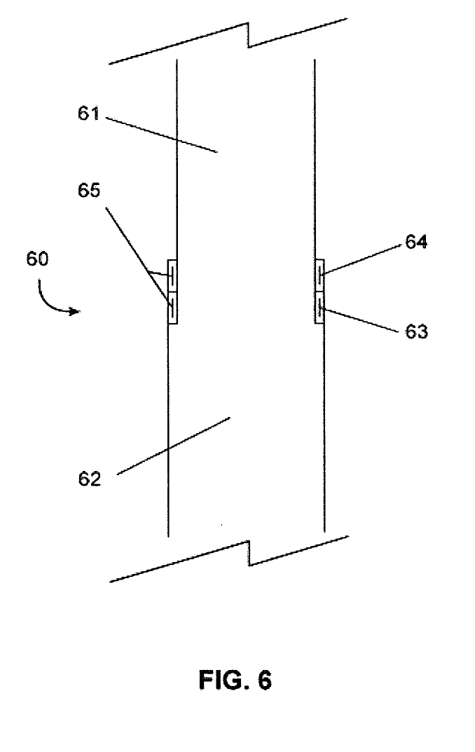

FIG. 6 is a cutaway side view of an embodiment of the two-piece filter bag 60 of the present invention shown assembled. Here, the top section 61 and the bottom section 62 have been fastened together by upper metal band 63 and lower metal band 64. The upper metal band 63 was telescoped and inserted past the metal band 64 in the bottom section 62. Although not always necessary, in the embodiment of FIG. 6 the upper metal band has been subsequently expanded to facilitate interlocking section 65. As explained above, other fastening means may be utilized.

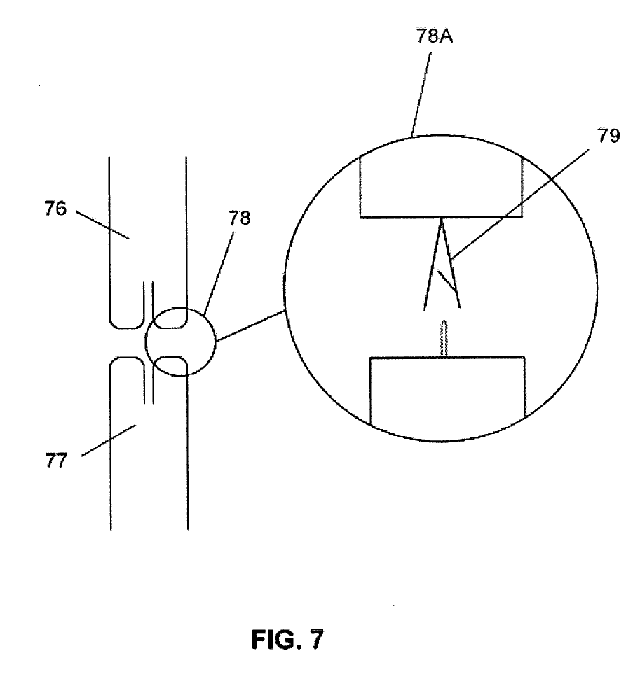

FIG. 7 is a cutaway side view of a modular bag cage of the present invention. Top cage section 76 is to be fastened to bottom cage section 77 by fastening means 78. Fastening means 78 has been enlarged as 78A and the fastening means is shown to be spring clip 79. Other means for fastening such as using nuts, screws, clips, or other means suitable for the purpose may, of course, be utilized.

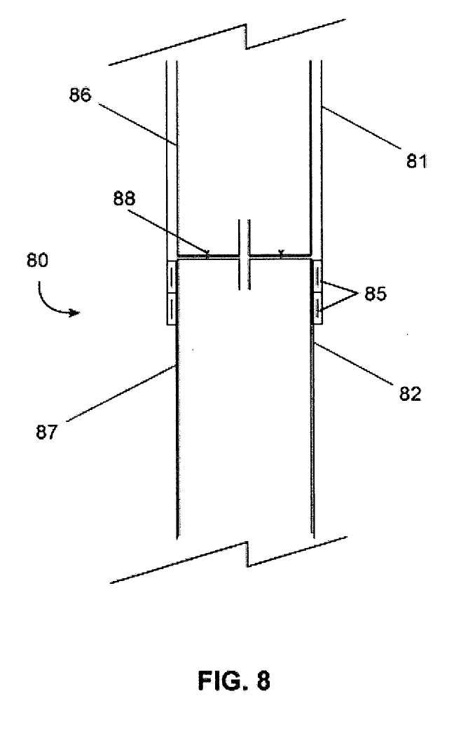

FIG. 8 is a cutaway side view of an embodiment of an assembled two-piece filter bag and modular support cage system 80 of the present invention. The top section 81 of the filter bag is shown fastened to the bottom section of the filter bag 82 by way of fastening means 85. Similarly, the top section of the support cage 86 is shown fastened to the bottom section of the support cage 87 by fastening means 88. Although FIG. 8 and the other Figures show only two-piece embodiments, any number of bag sections and cage sections may be utilized.

For single cage configurations, the present invention has the advantage of allowing the bottom section of the bag filter to be installed into the cell plate orifice first. The single construction cage can then be inserted halfway, the reduced bag length thus facilitating alignment. The top section of the bag may then be placed over the top of the single construction cage (the upper cage rim will, of course, need to be removed for this purpose) and connected to the bottom section near the orifice. Once connected, the remaining half of the assembly can be slowly inserted. Thus bag-to-cage alignment is facilitated, avoiding damage that may be caused to the filter bags due to misalignment as depicted in FIG. 3.

For modular cage configurations, the present invention facilitates at least two advantageous types of installations. First, the present invention would allow the bottom section of the filter cage to be inserted into the bottom section of the filter bag prior to installation in the collector. The integrity of alignment between the cage and bag in this bottom section could be achieved prior to installation in the collector. Because the modular cage sections are smaller and easier to handle, unlike the single construction cage, the bag and cage assembly may be precisely inserted into the cell plate orifice.

This first installation process would then entail the steps of: inserting the bottom half of the assembled bag and cage into the cell plate orifice first; connecting or attaching the top half of the filter bag to the bottom half; securing the assembled filter bag to the cell plate orifice; and inserting and securing the top half of the filter cage into the assembled filter bag bag.

Second, the present invention allows the bottom section of the filter bag to be inserted into the cell plate orifice. While holding the bag in place, the first cage section may be inserted into the bag with the short bag length facilitating bag-to-cage alignment. Thus, initial alignment is maximized. Once the initial bag section and cage section are inserted, subsequent bag and cage sections may be inserted using the same procedure until the bag and cage assembly is completely installed.

This second installation process would then entail the steps of: (a) inserting the first section of the filter bag into the cell plate orifice; (b) inserting the first section of the filter cage into the first section of the filter bag; (c) connecting a subsequent filter bag section to the previous section; (d) connecting a subsequent filter cage section to a previous section; and (e) repeating steps (c) and (d) until the installation is complete.

In the above filter bag and cage configurations and installation processes, there can be a number of filter bag sections. For example, it may include a bottom section, a top section, and an intermediate section (a section positioned between the top and bottom sections). The bottom filter bag section and the top filter bag section each have at least one open end and the intermediate filter bag section has two open ends. These sections connect to each other to form a filter bag as follows. In a two-section (top and bottom section) filter bag configuration, the open ends of the top and bottom sections connect to one another and the unconnected end of the bottom section connects to the cell plate orifice. In a filter bag configuration having more than two sections, i.e. a configuration having at least one intermediate section, the open ends of the top and bottom filter bag sections connect to the open ends of the intermediate filter bag section(s). Any number of intermediate filter bag sections can be connected to one another to form a desired length of the filter bag.

Thus by the present invention, its objects and advantages are realized, and although preferred embodiments have been disclosed and described in detail herein, its scope should not be limited thereby; rather its scope should be determined by that of the appended claims.

What is claimed is:

1. A filter bag assembly comprising:
a plurality of elongated filter bag sections having a top end, bottom end, inside surface, and outside surface; and
a means for fastening the filter bag sections together.

2. A filter bag assembly in accordance with claim 1 wherein the plurality of sections comprise:
a bottom filter bag section; and
a top filter bag section.

3. A filter bag assembly in accordance with claim 1 wherein the plurality of sections comprise:
a bottom filter bag section;
at least one intermediate filter bag section; and
a top filter bag section.

4. A filter bag assembly according to claim 2 wherein:
the bottom elongated filter bag section has at least one open end; and
the top elongated filter bag section has at least one open end,
wherein the at least one open ends of the bottom elongated filter bag section and the top elongated filter bag section connect to one another.

5. A filter bag assembly according to claim 3 wherein:
the bottom elongated filter bag section has at least one open end;
the top elongated filter bag section has at least one open end; and
the intermediate filter bag section has two open ends,
wherein the at least one open ends of the bottom elongated filter bag section and the top elongated filter bag section connect to the two open ends of the intermediate filter bag section.

6. A filter bag and cage assembly comprising:
a plurality of elongated filter bag sections having a top end, bottom end, inside surface, and outside surface;
a means for fastening the filter bag sections together;
a plurality of supporting cage sections having a plurality of longitudinal elements and support elements; and
a means for fastening the cage sections together.

7. A filter bag and cage assembly in accordance with claim 6 wherein the plurality of elongated filter bag sections comprise:
a bottom filter bag section and;
a top filter bag section.

8. A filter bag and cage assembly in accordance with claim 6 wherein the plurality of elongated filter bag sections comprise:
a bottom filter bag section;
at least one intermediate filter bag section; and
a top filter bag section.

9. A filter bag and cage assembly according to claim 7 wherein:
the bottom elongated filter bag section has at least one open end; and
the top elongated filter bag section has at least one open end,
wherein the at least one open ends of the bottom elongated filter bag section and the top elongated filter bag section connect to one another.

10. A filter bag and cage assembly according to claim 8 wherein:
the bottom elongated filter bag section has at least one open end;
the top elongated filter bag section has at least one open end; and
the intermediate filter bag section has two open ends,
wherein the at least one open ends of the bottom elongated filter bag section and the top elongated filter bag section connect to the two open ends of the intermediate filter bag section.

11. A method of inserting a filter bag assembly into a cell plate orifice comprising the steps of:
inserting a bottom section of the filter bag into the cell plate orifice;
inserting a single construction cage through the cell plate orifice and into the bottom filter bag section;
inserting a top section of the single construction cage into a top section of the filter bag by placing the filter bag over the top section of the single construction cage; and
connecting the filter bag sections.

12. A method of inserting a filter bag assembly into a cell plate orifice comprising the steps of:
inserting a bottom section of a filter cage into a bottom section of a filter bag;
inserting a bottom section of the assembled bag and cage into a cell plate orifice;
connecting a top section of the filter bag to the bottom section;
securing the assembled filter bag to the cell plate orifice; and
inserting and securing the top section of the filter cage into the assembled filter bag.

13. A method of inserting a filter bag assembly into a cell plate orifice comprising the steps of:
(a) inserting a first section of a filter bag into the cell plate orifice;
(b) inserting a first section of a filter cage into the first section of the filter bag;
(c) connecting a subsequent filter bag section to a previous section;
(d) connecting a subsequent filter cage section to a previous section; and
(e) repeating steps (c) and (d) until installation is complete.
